(19) United States
(12) Patent Application Publication
(10) Pub. No.: US 2015/0079954 A1
(43) Pub. Date: Mar. 19, 2015

(54) ADVANCED SYSTEM AND INTERNET APPLICATION FOR NON-COMMERCIAL COMMUNICATION TO CELLULAR DEVICES AND CELLULAR COMMUNICATIONS RESEARCH

(71) Applicant: Evolving Strategies, LLC, Arlington, VA (US)

(72) Inventor: Adam B. Schaeffer, Arlington, VA (US)

(73) Assignee: Evolving Strategies, LLC, Arlington, VA (US)

(21) Appl. No.: 14/459,033

(22) Filed: Aug. 13, 2014

Related U.S. Application Data
(60) Provisional application No. 61/865,367, filed on Aug. 13, 2013.

(51) Int. Cl. H04M 3/487; H04W 4/12

(52) U.S. Cl. CPC H04M 3/4872; H04W 4/12
USPC 455/414.1

(57) ABSTRACT

A communications and data system that is efficient and easy to use and solves potential regulatory and legal problems with the use of current text message systems for delivering non-commercial messages to cellular phones without explicit prior consent from those contacted. It also creates a research platform for investigating the effectiveness of communications to cellular phones. The system includes a database with a contact data file and a contact group. It also includes an administrative function that creates a task to match a specific message to a specific contact group. The administrative function is configured to control message, task and group assignments to enable the execution of methodologically sound randomized-controlled experiments to advance communications research.

### CROSS REFERENCE TO RELATED APPLICATION

This application is a nonprovisional and claims the priority benefit of U.S. provisional patent application Ser. No. 61/865,367, filed Aug. 13, 2013, entitled “An Advanced System and Internet Application for Noncommercial Communication to Cellular Devices and Cellular Communications Research” by the same inventor. The entire content of that application is incorporated herein by reference.

### BACKGROUND OF THE INVENTION

1. Field of the Invention

This invention is an internet (web)-based application that ensures volunteers and paid workers cm easily communicate non-commercial text for oral) messages to voters and easily collect and transfer the resulting data to other applications for research and analysis, while complying with currently stated FCC regulations and enforcement guidelines regarding non-commercial, text messaging calls to cell phones.

2. Description of the Prior Art

Published FCC guidelines and regulations indicate that text messaging to cell phone numbers is the equivalent of voice calls to those same numbers and are therefore subject to the same guidelines, regulations and restrictions. We will therefore refer to both text messaging and calls to cellular phones as “calls.”

No commercial calls may be made to cell phones unless prior, explicit, written, permission is obtained by the caller. Non-commercial calls, for educational and political (non-commercial) purposes, may be made manually to cell phones without prior consent. Clearly, any system that dials a number without any human input whatsoever is considered “automatic.” However, it seems that anything short of the manual input of the full, seven-digit phone number may also be considered “automatic,” and therefore be prohibited. For instance, if a phone number has been stored in a computing device, such as a desktop computer, laptop or even smart phone, and a caller pushes one button or taps the screen to dial that number, this can be considered prohibited “automatic” dialing.

All automatic dial systems are prohibited from use for cellular calls. The FCC has made clear that “automatic dial, systems” are prohibited, even if the capacity for automatic dialing is not used in a particular instance. The FCC prohibition “covers any equipment that has the specified capacity to dial numbers without human intervention.” In short, use of any equipment or system that has the capacity to execute automated calls to call cellular numbers is in violation of regulatory guidelines stated in the most recent relevant FCC Enforcement Advisory, See Enforcement Advisory No. 2012-06:
“There are no restrictions on live manually-dialed political calls, which may be delivered to any landline telephone or cell phone.”
“An autodialed call is any type of call or message, including a text message, that is made by an ‘autodialer’ or ‘automatic telephone dialing system,’ which is “equipment which has the capacity to store or produce telephone numbers to be called using a random or sequential number generator and to dial such numbers.¹ The Commission has emphasized that this definition covers any equipment—including predictive dialers—that has the specified capacity to dial numbers without human intervention whether or not the numbers called actually are randomly or sequentially generated or come from calling lists.²”¹ 47 C.F.R. §64.1200(f)(2) (formerly codified at 47 C.F.R. §64.1200(f)(1)); see also 47 U.S.C. §227(a)(1).² Rules and Regulations Implementing the Telephone Consumer Protection Act of 1991, Report and Order, 18 FCC Red 14014, 14092-93, para. 133 (2003). Predictive dialers use automated equipment to dial numbers (either from lists or randomly or sequentially) and then connect the called party to a live person. The distinctive element of a predictive dialer is software that predicts calling patterns to minimize the time live agent spend between calls while also minimizing the incidence of individuals answering a call when no agent is available.

Unfortunately, existing text message applications and systems are oriented toward serving commercial customers, who do not have an exemption for manually dialed messages; all commercial cellular calls must be made only in the case of expressed prior consent. These systems allow for automatic calls to cellular devices, thus violating stated FCC guidelines. Furthermore, current cellular calling systems are of limited utility for conducting non-commercial and particularly political communications research. There is no means of ensuring that a particular text message is sent to particular numbers by specific users of the systems, which undermines project controls and quality assurance. In addition, because of the absence of these controls and use limitations, randomized-controlled experiments are impossible to execute with the requisite certainty for such a method.

### SUMMARY OF THE INVENTION

The present invention creates a communications and data system that is efficient and easy to use and solves numerous clearly stated and potential regulatory and legal problems with the use of current text message systems and applications for delivering non-commercial messages to cellular phones without explicit prior consent from those contacted. It also creates a precise research platform for investigating the effectiveness of communications to cellular phones.

### BRIEF DESCRIPTION OF THE DRAWINGS

FIG. 1 is a representation of a user interlace for entry to a computer application of the present application.

FIG. 2 is a representation of a table of user messaging information generated using the present invention.

FIG. 3 is a representation of a user interface showing group adding options.

FIG. 4 is a representation of a user interlace for adding specific group contact information.

FIG. 5 is a representation of a user interface showing user information and access options.

FIG. 6 is a representation of a user interface for adding specific user information.

FIG. 7 is a representation of a user interface showing task options for a user of the application.

FIG. 8 is a representation of a user interlace for adding a task that may be performed by a user.

FIG. 9 is a representation of a user interlace showing a specific task selected.

FIG. 10 is a representation of a user interface showing input for contacting a party.

FIG. 11 is a representation of a user Interface showing application error feedback from an input task.

FIG. 12 is a simplified representation of a computing system that may be used to carry out the functions embodied in the application of the present invention reflected in FIGS. 1-11.

### DESCRIPTION Of THE INVENTION

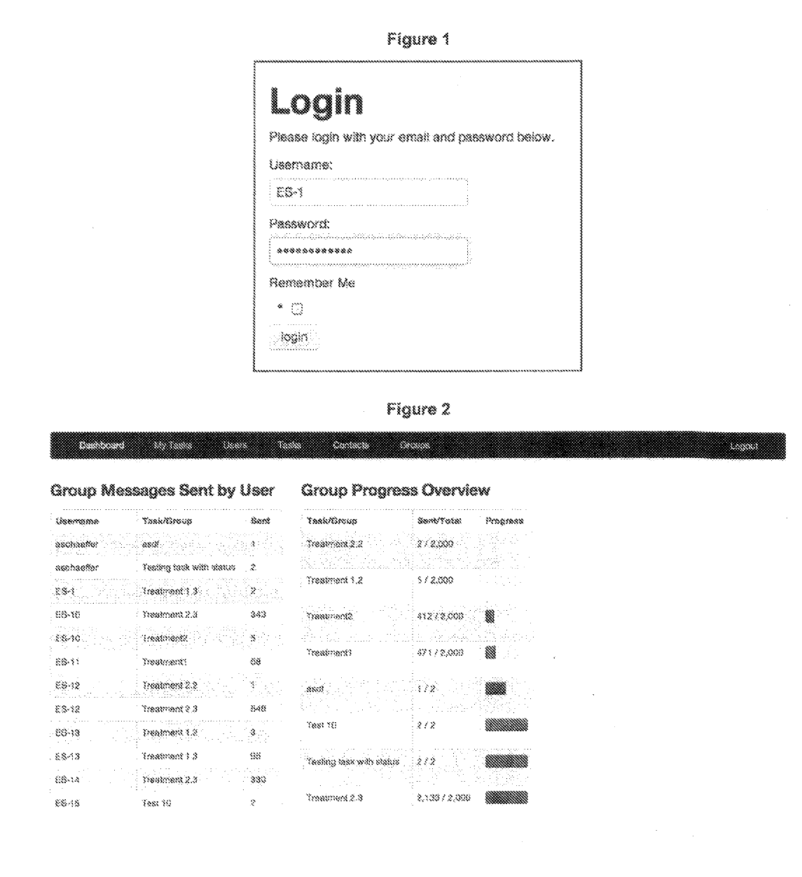

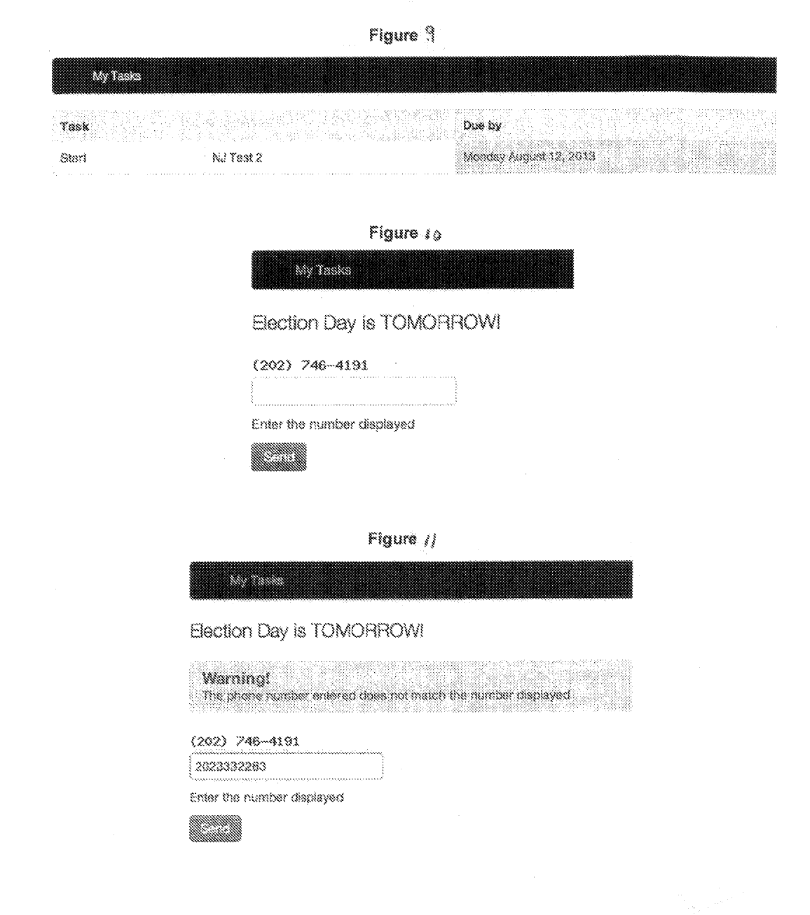

The present invention is a computer program performed using a computing device to carry out specific instructions as illustrated in FIGS. 1-11.

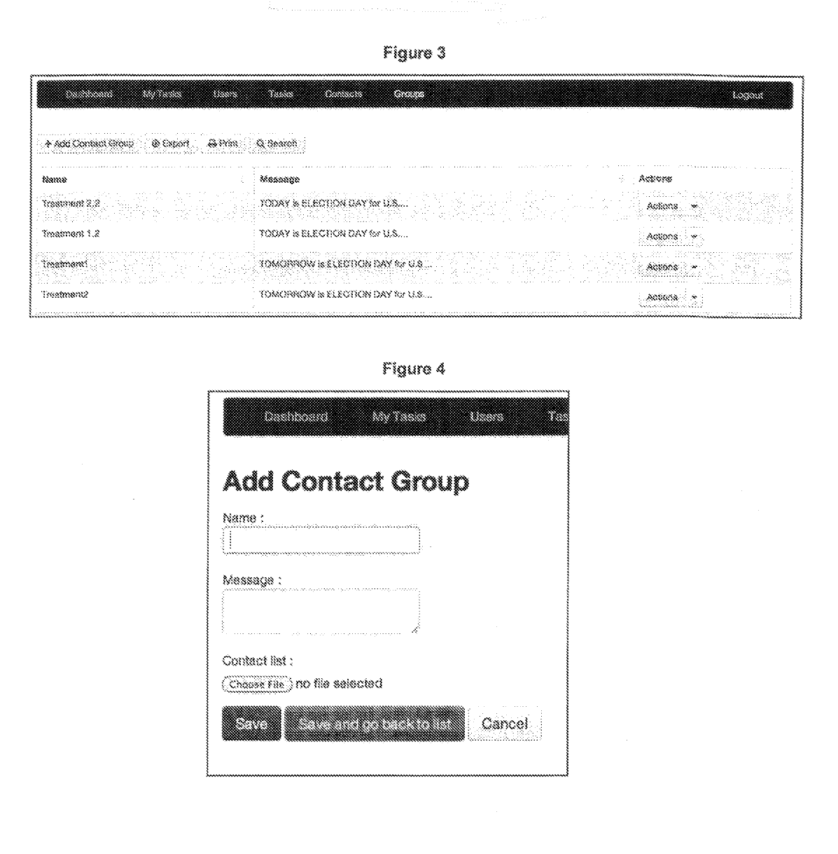

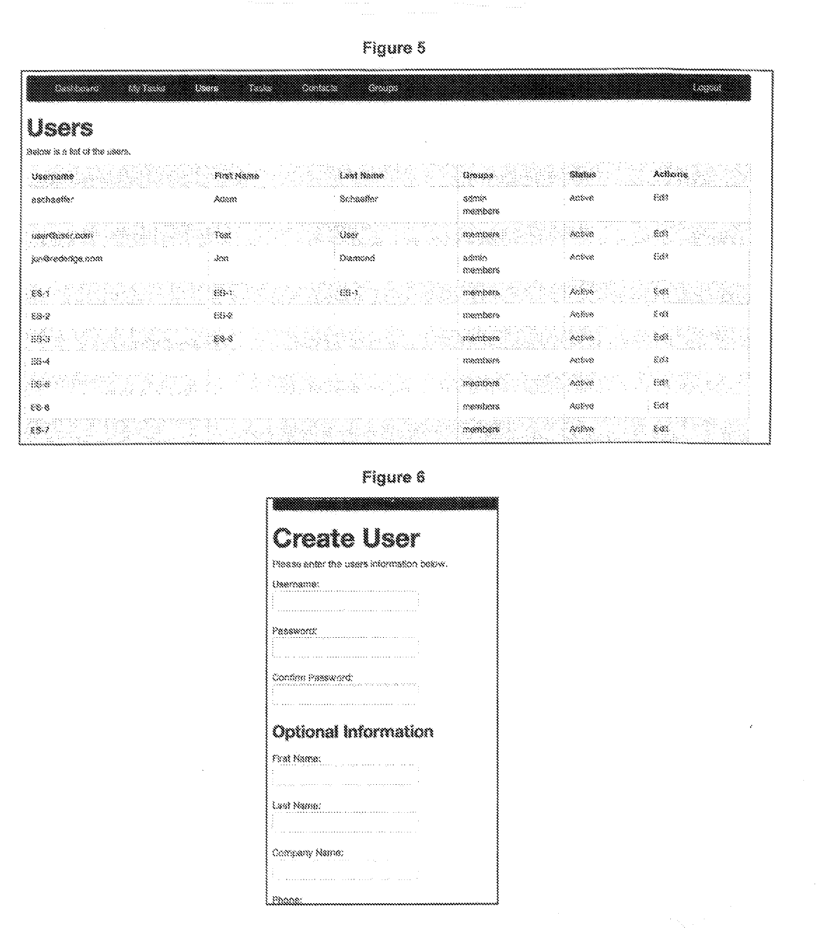

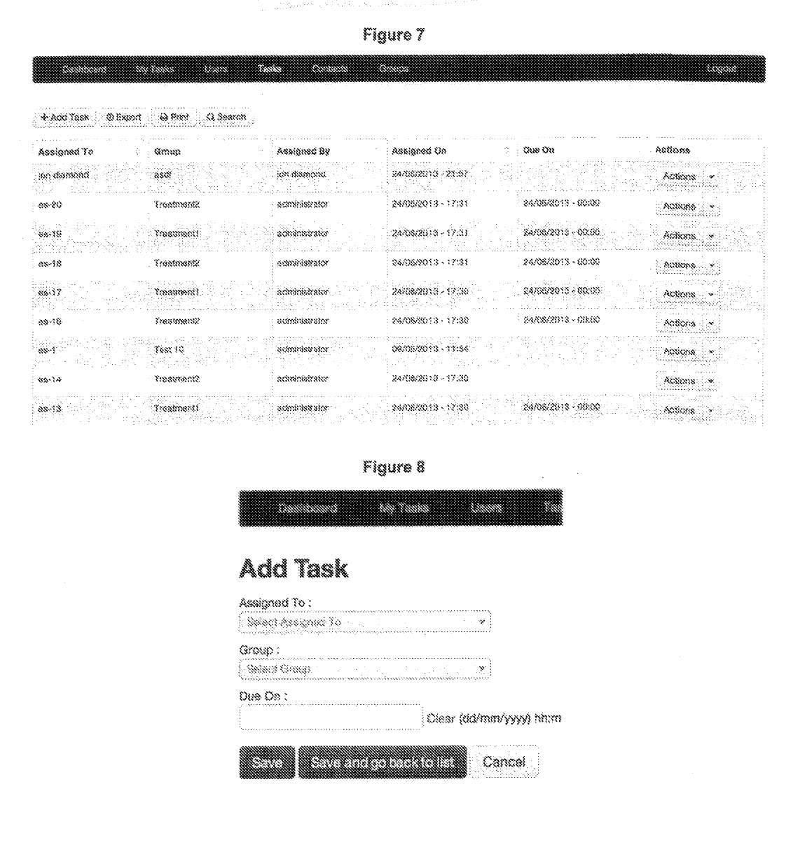

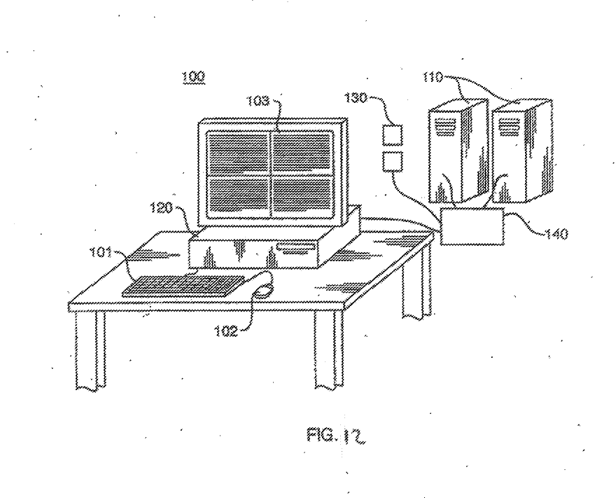

Steps of the program include:
1. An Administrator uploads and stores Contact data file (e.g. voterfiles (See FIGS. 3, 4)
2. An Administrator creates a contact Group that consists of a specific data file. (See FIG. 4)
3. An Administrator creates a Task, which matches a specific text Message to a specific contact Croup. The Message may be assigned to a whole Group, or to specific Contacts within a Group, based on associated data or other criteria established by the Administrator. (See FIGS. 7, 8)
   a. The precise control of Message, Task, Group, and User assignments allows the execution of methodologically sound randomized-controlled experiments to advance communications research.
   b. Randomization of source tiles for Group, Message, Task and User assignment may be conducted within the system, with automatic assignment based on automatic randomization coding (with checks for balance before assignment) or outside the system and then structured manually by an Administrator in the assignment of Groups, Messages, Tasks and Users according to the research design and randomization results.
4. An Administrator creates a User account (and multiple accounts) with restricted access to the program, allowing Users to access only the Task interlace and other necessary pages. (See FIGS. 5,6)
5. An Administrator can also create other sub-accounts for additional Administrators with access to particular data, numbers, Tasks, Users, etc, (See FIG. 6)
6. An Administrator can assign a phone number to each User individually, or assign a series of phone numbers to a Task. If phone numbers are assigned to a Task, then each User will automatically be assigned, one of the Task phone number when the User is assigned to the Task. (See FIG. 6)
7. An Administrator assigns a Task to Users. Tasks may be assigned in. batches to many Users or individually to one User. (See FIGS. 7, 8)
8. Users log into the system and are presented with a Task (or multiple Tasks) in a Dashboard user interface. (See FIG. 7)
9. When a User chooses a Task, the User is brought to the text message interface. (See FIG. 8)
   a. An image (non-text) of a telephone number from the Group list is presented above an input line.
   b. The interface may or may not present the text message associated with this Task.
   c. Because the phone number is an image, the number cannot be copy and pasted into the input held.
   d. The User must type the presented phone number into the input held by hand.
   e. If the number is incorrect the interface will change colors, present error text, or otherwise indicate that the number typed into the input field is incorrect. No text message can be sent unless the typed number correctly matches the number in the source data file for the assigned Group. (See FIG. 11)
   f. The input field and interface allow only one number to be typed and sent at a time. There is no capability whatsoever for sending multiple messages or Inputting a number without manually typing the number.
   g. The User clicks the “send” button or an equivalent method of causing the text message assigned to the Task to be sent to the number typed into the input field. (See FIG. 10)
   h. Once the User has sent a text message, another phone number from, the Task Group is presented as an image on the user interface page.
   i. Internal timing controls on the pace of sending ensure that no User can exceed commercial or regulatory limits on the number of texts sent per unit of tune.
   j. This process is repeated until messages have been sent to all numbers in the Task Group, the User discontinues the process, or an Administrator discontinues the Task.
10. All Contact records are tagged as having been attempted/successfully sent a text.
11. All Contact records are tagged with identification codes indicating which message was sent and other relevant information, including text responses indicating that the Contact wishes to be removed, from all future communications.
12. Delivery of the text message to a Contact's device may be completed by systems custom-built for the Invention or interfacing with any number of Short Message Services (SMS) such as (but not limited to): http://www.twilio.com/sms, https://www.tropo.com/how-it-works/home.jsp, http://www.plivo.com/open-source/, etc.

The present invention is a web-based computer-configured system and method that enable users including, but not limited to, volunteers and paid workers, to easily communicate non-commercial text (or oral) messages to voters and other types of recipients and easily collect and transfer the resulting data to other applications for research and analysis, while complying with currently stated FCC regulations and enforcement guidelines regarding non-commercial text messaging calls to cell phones. The system and method and are embodied in a computing system programmed to perform functional steps associated with the gathering of the information for the purpose of accessing it and carrying out instructions based on that information. Any type of computing system suitable to store information in the amount of interest and to generate and/or initiate instructions of interest on the information may be employed and is represented generally in FIG. 12. The computer system 100 shown is only one example of a suitable computing environment and is not intended to suggest any limitation as to the scope of use or functionality of the invention. For example, the computer system 100 may be associated with local or remote computing means, such as one or more central computers, such as server 110 in a local area network, a metropolitan area network, a wide area network, or through intranet and internet connections.

The computer system 100 may include one or more discrete computer processor devices, represented by desktop computer 120, for example. Examples of well-known computing devices that may be suitable for use with the invention include, but are not limited to, cell phones, smart phones, personal computers, server computers, hand-held or laptop devices, tablet computers, multiprocessor systems, microprocessor-based systems, set top boxes, programmable consumer electronics, network PCs, minicomputers, mainframe computers, distributed computing environments that include any of the above systems or devices, and the like. The computer system 100 may include computer devices operated by one or more users, such as through a desktop, laptop, or servers, and/or one or more providers of services corresponding to one or more functions of the invention.

The server 110, the computer processor 120, or a combination of both may be programmed to include one or more of the functions of the invention system. A database of the present invention for gathering, storing and making accessible the information of interest and transmittable messages, is represented by Database 130. For the purpose of the description of the present invention, a database is a collection of stored data that are logically related. Although there are different types of databases, and the Database 130 of the present invention may be any of such types, it is preferably a database with a database management system, comprising tables made up of rows and columns. Data stored in the tables are accessed or updated using database queries submitted to the database system.

Database 130 may be associated with the server 110, the computer processor 120, other computing devices, or any combination thereof and includes information related to the use of the system of the present invention. The Database 130 may be associated with a single computing device or a plurality of devices. The Database 130 may be centrally located or it may be distributed locally or widely. The Database 130 is populated and updated with information associated with the research, polling, content and other information of interest for the purpose of the invention. All of the devices may be interconnected through one or more signal exchange devices, such as router/switch 140.

The invention may be described in the general context of computer-executable instructions, such as program modules, being executed by a computer such as the computer system 100. Generally, program modules include routines, programs, objects, components, data structures, etc. that perform particular tasks or implement particular abstract data types. As indicated above, the system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices.

The computer processor 120 and interactive drives, memory storage devices, databases, including hut not limited to the Database 130, and peripherals may be interconnected through one or more computer system buses. The system buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component interconnect (PCI) bus.

The computer system 100 typically includes a variety of computer readable media. Computer readable media can be any available media that can be accessed by computer system 100 and includes both volatile and non-volatile media, removable and non-removable media. By way of example, and not limitation, computer readable media may comprise computer storage media and communication media. Computer storage media include volatile and non-volatile, removable and non-removable media implemented in any method or technology tor storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100.

The computer system 100 further includes computer storage media in the form of volatile and/or non-volatile memory such as Read Only Memory (ROM) and Random Access memory (RAM). RAM typically contains data and/or program modules that are accessible to and/or operated on by computer processor 120. That is, RAM may include application programs, such as the functional modules of the system of the present invention, and information in the form of data. The computer system 100 may also include other removable/non-removable, volatile/non-volatile computer storage and access media. For example, the computer system 100 may include a hard disk drive to read, from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system 100 to perform the functional stops associated with the system and method of the present invention include, but are not limited to, magnetic tape cassettes, flash memory cards, digital versatile disks, digital video tape, solid stare RAM, solid state ROM, and the like.

The drives and their associated computer storage media described above provide storage of computer readable instructions, data structures, program modules and other data for the computer processor 120. A user may enter commands and information into the computer processor 120 through input devices such as a keyboard 101 and a pointing device 102, commonly referred to as a mouse, trackball or touch pad. Other input devices (not shown) may Include a microphone, joystick, game pad, satellite dish, scanner, or the like. These and other input devices are connected to the computer processor 120 through the system bus, or other bus structures, such as a parallel port, game port or a universal serial bus (USB), but is not limited thereto. A monitor 103 or other type of display device is also connected to the computer processor 120 through the system bus or other bus arrangement. In addition to the monitor 103, the computer processor 120 may be connected to other peripheral output devices, such as printers (not shown). Commands and information may be entered by one or more users any one or more of whom may be located in the same or different locations. Commands and information may be entered at designated or random times.

The computer processor 120 may be configured and arranged to perform functions and steps embodied in computer instructions stored and accessed in any one or more of the manners described. The functions and steps, such as the functions and steps of the implementation of the algorithm of the present invention described above, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such, signals define instructions, for example, as part of one or more programs that, as a result of being executed by the computer processor 120, instruct the computer processor 120 to perform one or more processes or acts described herein, and/or various examples, variations and combinations thereof Such instructions may be written in any of a plurality of programming languages, for example, XML, JAVA, C++, or any other language suitable for the purpose of the present invention, or any of a variety of combinations thereof. Information entry may be effected using such programming languages as well as other applications including for example and in no way limited thereto, database programs ACCESS and DB2. The computer-readable medium on which such instructions are stored may reside on one or more of the components described above and may be distributed across one or more such components.

The present invention has been described with respect to a specific example represented by the accompanying screenshots. It is not intended to be limited thereto.

1. A computer-based system to facilitate the communication of one or more non-commercial messages to one or more cell phones of one or more recipients in compliance with regulations, the computer-based system comprising;
a. a database including a contact data file and a contact group;
b. an administrative junction carried out by a computer processor, wherein the administrative function creates a task, which matches a specific message to a specific contact group, wherein the administrative function is configured to control message, task and group assignments to enable the execution of methodologically sound randomized-controlled experiments to advance communications research.

2. The system of claim 1, wherein randomization of source files for group, message, task and user assignment may be conducted with automatic assignment based on automatic randomization coding.

3. A computer-based method to facilitate the communication of one or more non-commercial messages to one or more cell phones of one or more recipients in compliance with regulations, the method comprising the steps of:
a. creating in a database a contact data file and a contact group;
b. creating a task, which matches a specific message to a specific contact group; and
c. controlling message, task and group assignments to enable the execution of methodologically sound randomized-controlled experiments to advance communications research.

4. The method of claim 3 wherein randomization of source files for group, message, task and user assignment may be conducted with automatic assignment based on automatic randomization coding.
